(19) United States
(12) Patent Application Publication
(10) Pub. No.: US 2014/0106133 A1
(43) Pub. Date: Apr. 17, 2014

(54) LAMINATE

(71) Applicant: NITTO DENKO CORPORATION, Osaka (JP)

(72) Inventors: Tsuyoshi Torinari, Osaka (JP); Eiji Toyoda, Osaka (JP); Yusaku Shimizu, Osaka (JP); Daisuke UENDA, Osaka (JP)

(73) Assignee: NITTO DENKO CORPORATION, Osaka (JP)

(21) Appl. No.: 14/051,120

(22) Filed: Oct. 10, 2013

(30) Foreign Application Priority Data
Oct. 11, 2012 (JP) 2012-226085

(51) Int. Cl. B32B 27/08; B32B 27/36; B32B 27/38

(52) U.S. Cl. CPC B32B 27/08; B32B 27/38; B32B 27/36
USPC 428/189; 428/414

(57) ABSTRACT

An object of the invention is to prevent staining of processing equipment by a resin originated from a resin sheet during pressing. The present invention achieves the object by a laminate having a support, a resin sheet that is laminated on a part of the support, and a release sheet that is laminated on the resin sheet, in which a peel force F1 between the support and the resin sheet is larger than a peel force F2 between the resin sheet and the release sheet.

### BACKGROUND OF THE INVENTION

1. Field of the Invention

The present invention relates to a laminate.

2. Description of the Related Art

A surface protective film that is pasted to a surface to be protected of an optical resin plate, an optical resin sheet, a synthetic resin plate, or the like has been conventionally known (see, for example, JP-A-2009-241487). This surface protective film is aimed at protecting the surface to be protected from scratches, dusts, staining, and the like during transportation and storage.

Conventionally, the surface protective films are sometimes pasted on both surfaces of the resin sheet and transported or stored in this state. One of the surface protective films is peeled off when the resin sheet is actually used, and the resin sheet is processed into a desired shape with the surface protective film provided on the other surface. After that, the surface protective film is peeled off from the resin sheet.

### SUMMARY OF THE INVENTION

The conventional surface protective film has the same shape in plan view as the resin sheet to which the film is pasted. Because of that, when pressing is performed on the resin sheet that is provided on the surface protective film, the resin protrudes and attaches to processing equipment such as a pressing plate to cause staining.

The present invention was made in view of the above-described problem, and an object thereof is to prevent staining of processing equipment by the resin originated from the resin sheet during pressing.

The present inventors made an investigation to solve the conventional problem. As a result, they found that the object can be achieved by adopting the following configuration, and completed the present invention.

That is, the laminate according to the present invention has a support, a resin sheet that is laminated on a part of the support, and a release sheet that is laminated on the resin sheet, and in which a peel force F1 between the support and the resin sheet is larger than a peel force F2 between the resin sheet and the release sheet.

According to the above configuration, the resin sheet is laminated on a part of the support, and on the support, there is a part where the resin sheet is not laminated. Because of that, when the resin sheet in a state of being laminated on the support is pressed, the resin spreads on the part of the support where the resin sheet is not laminated. As a result, the protrusion of the resin on the support can be prevented, and the attachment of the resin to processing equipment such as a pressing plate can be prevented. Therefore, staining of the equipment can be suppressed. In addition, positioning of the resin sheet upon pressing can be performed using the part of the support where the resin sheet is not laminated. The staining of the equipment by the resin can be suppressed due to the existence of the support. Therefore, it is not necessary to provide a protective material or a release film on a top plate of the pressing plate to prevent the attachment of the resin. Because the peel force F1 between the support and the resin sheet is larger than the peel force F2 between the resin sheet and the release sheet, the release sheet can be easily peeled off from the support without peeling the resin sheet off during pressing.

In the above-described configuration, when the resin sheet in a state of being laminated on the support is pressed at a press temperature of 60 to 110° C., the resin sheet preferably does not protrude from the support in plan view. When the resin sheet does not protrude from the support in plan view upon pressing under the above-described condition, the staining of processing equipment can be further suppressed.

In the above-described configuration, the tensile storage modulus of the support is preferably 1.5 to 5 GPa at 25° C. When the tensile storage modulus of the support is 1.5 GPa or more, handling becomes easy. When the tensile storage modulus of the support is 5 GPa or less, peeling of the resin sheet from the support can be prevented. Cracking of the resin sheet can also be prevented.

In the above-described configuration, the area of the support is preferably larger than that of the release sheet in plan view. When the area of the support is larger than that of the release sheet in plan view, the support and the release sheet can be easily distinguished from each other. As a result, the front side can be easily distinguished from the rear side.

In the above-described configuration, the coefficient of linear thermal expansion of the support is preferably 3 to 15 ppm/° C. in a region (α1 region) of equal to or less than the glass transition temperature, and 20 to 60 ppm/° C. in a region (α2 region) of equal to or more than the glass transition temperature. When the coefficient of linear thermal expansion of the support is within the above-described range, the support is considered to have heat resistance (especially, to the heat of about 150° C.) As a result, the support is sufficiently durable against the heat during pressing. The coefficient of linear heat expansion can be obtained by TMA (Thermal Mechanical Analysis).

### BRIEF DESCRIPTION OF THE DRAWINGS

FIG. 1A is a cross-sectional view schematically showing the laminate according to the present embodiment, and FIG. 1B is a planar drawing of the laminate.

### DETAILED DESCRIPTION OF THE PREFERRED EMBODIMENT

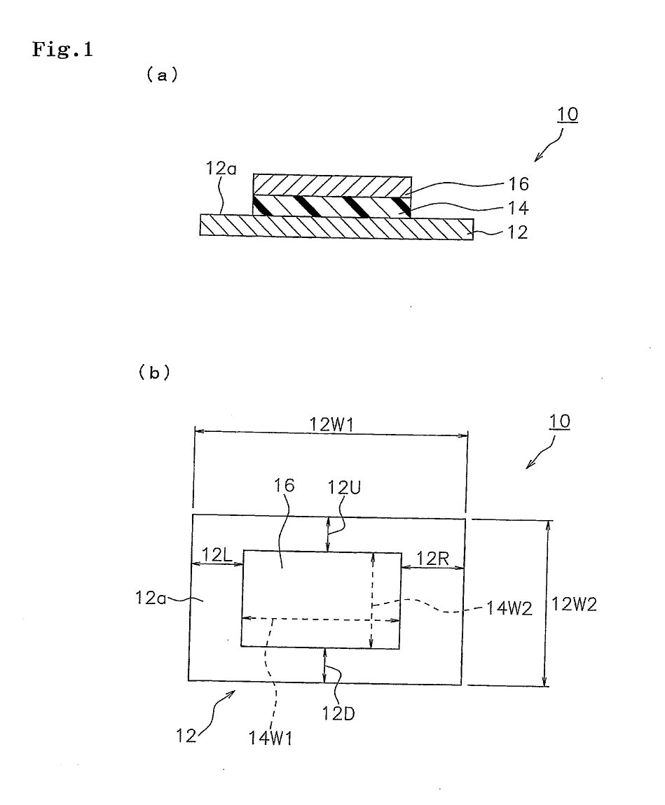

An embodiment of the present invention is explained by referring to the drawings. However, the present invention is not limited to these examples. FIG. 1A is a cross-sectional view schematically showing the laminate according to the present embodiment, and FIG. 1B is a planar drawing of the laminate.

As shown in FIGS. 1A and 1B, a laminate 10 has a support 12, a resin sheet 14 that is laminated on a part of the support 12, and a release sheet 16 that is laminated on the resin sheet 14. The resin sheet 14 is laminated on a part of the support 12 so that it does not protrude from the support 12 in plan view. With this, a part 12a where the resin sheet 14 is not laminated exists on the support 12. Because of that, when the resin sheet 14 in a state of being laminated on the support 12 is pressed, the resin spreads on the part 12a of the support 12 where the resin sheet is not laminated. As a result, the protrusion of the resin on the support 12 can be prevented within the area on the part 12a, and the attachment of the resin to processing equipment such as a pressing plate can be prevented. Therefore, staining of the equipment can be suppressed. The staining of the equipment by the resin can be suppressed due to the existence of the support 12. Therefore, it is not necessary to provide a protective material or a release film on a top plate of the pressing plate to prevent the attachment of the resin.

As described above, the resin sheet 14 is laminated on a part of the support 12 so that it does not protrude from the support 12 in plan view. The resin sheet 14 may be laminated on any position of the support 12 as long as it is laminated so that the part 12a exists in a state that it does not protrude from the support 12 in plan view. However, the resin sheet 14 is preferably laminated so that the width of the left side 12L of the part 12a from the resin sheet 14 is the same as the width of the right side 12R of the part 12a from the resin sheet 14 in plan view. Likewise, the resin sheet 14 is preferably laminated so that the width of the upper side 12U of the part 12a from the resin sheet 14 is the same as the width of the lower side 12D of the part 12a from the resin sheet 14 in plan view.

The breadth 12W1 of the support 12 should be larger than the breadth 14W1 of the resin sheet 14, preferably 1.2 to 1.5 times, and more preferably 1.2 to 1.3 times the breadth 14W1 of the resin sheet 14. In the same manner, the height 12W2 of the support 12 should be larger than the height 14W2 of the resin sheet 14, preferably 1.2 to 1.5 times, and more preferably 1.2 to 1.3 times the height 14W2 of the resin sheet 14. When the breadth 12W1 of the support 12 is 1.2 times or more the breadth 14W1 of the resin sheet 14, the protrusion of resin upon pressing can be more effectively suppressed. In the same manner, when the height 12W2 of the support 12 is 1.2 times or more the height 14W2 of the resin sheet 14, the protrusion of resin upon pressing can be more effectively suppressed. When the breadth 12W1 of the support 12 is 1.5 times or less the breadth 14W1 of the resin sheet 14, the handling at processing such as molding becomes easy, and the handling property can be improved. In the same manner, when the height 12W2 of the support 12 is 1.5 times or less the height 14W2 of the resin sheet 14, the handling at processing such as molding becomes easy, and the handling property can be improved. The breadth 12W1 and the height 14W2 of the support 12 can be appropriately set in accordance with the thicknesses of the resin sheet 14 before and after pressing and the pressure at pressing.

The present embodiment is explained on the assumption that the support 12 and the resin sheet 14 are rectangular in plan view. However, in the present invention, the shapes of the support and the resin sheet are not limited to this example. When the support and the resin sheet are not rectangular, the longest distances in the crosswise dimension (diameter in case of a round shape) of the support and the resin sheet are regarded as the breadth. In the same manner, the longest distances in the lengthwise dimension of the support and the resin sheet are regarded as the height.

In the laminate 10, the peel force F1 between the support 12 and the resin sheet 14 is larger than the peel force F2 between the resin sheet 14 and the release sheet 16. Because the peel force F1 is larger than the peel force F2, the release sheet 16 can be easily peeled off upon pressing without peeling the resin sheet 14 from the support 12. Examples of the method of making the peel force F1 larger than the peel force F2 include the selection of materials for the support 12 and the release sheet 16 and a surface treatment.

The peel force F1 is not especially limited as long as it is larger than the peel force F2. However, it is preferably 0.03 N/10 mm or more and 5 N/10 mm or less, and more preferably 0.05 N/10 mm or more and 3 N/10 mm or less under conditions of a measurement temperature of 23° C., a tensile speed of 0.3 m/min, and a peel angle of 180 degrees. When the peel force F1 is 0.03 N/10 mm or more, spontaneous peeling between the resin sheet 14 and the support 12 can be prevented. When the peel force F1 is 5 N/10 mm or less, the release sheet 16 can be easily peeled off from the resin sheet before pressing. In addition, deformation of the resin sheet 14 before curing can be prevented.

The peel force F2 is not especially limited as long as it is smaller than the peel force F1. However, it is preferably 0.01 N/10 mm or more and 3 N/10 mm or less, and more preferably 0.03 N/10 mm or more and 2 N/10 mm or less under conditions of a measurement temperature of 23° C., a tensile speed of 0.3 m/min, and a peel angle of 180 degrees. When the peel force F2 is 0.01 N/10 mm or more, spontaneous peeling between the resin sheet 14 and the release sheet 16 can be prevented. When the peel force F2 is 3 N/10 mm or less, only the release sheet 16 can be peeled off from the support 12 without peeling the resin sheet 14 off.

The material of the support 12 is not especially limited. However, examples include polyolefins such as low density polyethylene, linear polyethylene, medium density polyethylene, high density polyethylene, ultra low density polyethylene, random copolymer polypropylene, block copolymer polypropylene, homopolypropylene, polybutene, and polymethylpentene, an ethylene-vinylacetate copolymer, an ionomer resin, an ethylene-(meth)acrylic acid copolymer, an ethylene-(meth)acrylate (random and alternating) copolymer, an ethylene-butene copolymer, an ethylene-hexene copolymer, polyurethane, polyesters such as polyethylene terephthalate and polyethylene naphthalate, polycarbonate, polyimide, polyetheretherketone, polyetherimide, polyamide, wholly aromatic polyamide, polyphenylsulfide, aramid (paper), glass, glass cloth, fluororesin, polyvinyl chloride, polyvinylidene chloride, a cellulose-based resin, a silicone resin, metal (foil), and paper.

The surface of the support 12 may be subjected to a conventional surface treatment for the peeling property between the resin sheet 14 and the support 12. Examples of the surface treatment include chemical and physical treatments such as a chromic acid treatment, ozone exposure, flame exposure, high voltage electric shock exposure, and an ionized radiation treatment, and a coating treatment by a primer such as a release-treatment agent. Same type or different types of materials can be appropriately selected and used as the support 12, and several types of materials can be blended and used as necessary.

The thickness of the support 12 is not especially limited, and can be appropriately decided. However, it is preferably 25 to 100 μm, and more preferably 38 to 50 μm. When the thickness of the support 12 is 25 μm or more, the resin sheet 14 can be properly supported, and an excellent handing property can be obtained. Meanwhile, when the thickness of the support 12 is 100 μm or less, the handling property can be improved.

The tensile storage modulus of the support 12 is preferably 1.5 to 5 GPa, and more preferably 2 to 4.5 GPa at 25° C. When the tensile storage modulus of the support 12 is 1.5 GPa or more, the handling becomes easy. Meanwhile, when the tensile storage modulus of the support is 5 GPa or less, the peeling of the resin sheet 14 from the support 12 can be prevented. Cracking of the resin sheet 14 can also be prevented.

The coefficient of linear thermal expansion of the support 12 is preferably 3 to 15 ppm/° C., and more preferably 5 to 10 ppm/° C. in a region (α1 region) of equal to or less than the glass transition temperature. The coefficient of linear thermal expansion of the support 12 is preferably 20 to 60 ppm/° C., and more preferably 25 to 40 ppm/° C. in a region (α2 region) of equal to or more than the glass transition temperature. When the coefficient of linear thermal expansion of the support is within the above-described range, the support is considered to have heat resistance (especially, to the heat of about 150° C.). As a result, the support is sufficiently durable against the heat during pressing.

The support 12 may have a pressure-sensitive adhesive layer. With the pressure-sensitive adhesive layer, the resin sheet 14 can be securely pasted to the support 12. The material of the pressure-sensitive adhesive layer is not especially limited, and conventionally known materials can be adopted. An example is a general pressure-sensitive adhesive such as an acryl-based pressure-sensitive adhesive and a rubber-based pressure-sensitive adhesive. The pressure-sensitive adhesive layer may be formed from a radiation curing-type pressure-sensitive adhesive. As to the radiation curing-type pressure-sensitive adhesive, the degree of crosslinking can be increased by irradiation with radiation such as an ultraviolet ray to easily decrease the adhesive power. Therefore, the resin sheet 14 can be easily peeled off from the support 12 by irradiation with radiation after pressing.

The resin sheet 14 is an object of pressing. The material of the resin sheet 14 is not especially limited. However, conventionally known thermosetting resins can be mentioned as examples. A thermoplastic resin and various additives may be added as necessary. The use of the resin sheet 14 is not especially limited, and examples thereof include a resin sheet for sealing electronic parts, an underfill sheet, a film for the backside of a flip-chip semiconductor, and a die bond film. The resin sheet for sealing electronic parts is a sheet that is pasted to the surface of a substrate where electronic parts such as a semiconductor chip are mounted to embed the electronic parts. The underfill sheet is a sheet to seal a space between a circuit surface of a semiconductor chip and an electrode-formed surface of a substrate in a flip-chip semiconductor device. The film for the backside of a slip-chip semiconductor is a film to be formed on the backside (a non-circuit-formed surface) of a semiconductor element that is connected onto an adherend by flip-chip bonding. The die bond film is a film to die bond a semiconductor chip to an adherend.

The thickness of the resin sheet 14 is not especially limited, and it can be appropriately set in accordance with the use thereof, for example. However, it is generally 100 to 1000 μm, and preferably 200 to 750 μm.

The material of the release sheet 16 is not especially limited, and the same material as that for the support 12 can be used.

The surface of the release sheet 16 may be subjected to a conventional surface treatment for the peeling property from the resin sheet 14. The same surface treatment as for the support can be adopted.

The thickness of the release sheet 16 is not especially limited, and can be appropriately decided. However, it is preferably 38 to 75 μm, and more preferably 38 to 50 μm. When the thickness of the release sheet 16 is 38 μm or more, a certain level of hardness can be obtained, and the handling property can be improved. Meanwhile, when the thickness of the release sheet 16 is 75 μm or less, peeling of the resin sheet from the support can be prevented. Cracking of the resin sheet can also be prevented.

In the present embodiment, the shape of the release sheet 16 is the same as that of the resin sheet 14 in plan view. However, the shape of the release sheet in the present invention is not limited to this example. However, from the viewpoint of protecting the surface of the resin sheet 14 before pressing, the release sheet 16 is preferably formed so that it at least covers the entire resin sheet 14.

The area of the support 12 is larger than that of the release sheet 16 in plan view. When the area of the support 12 is larger than that of the release sheet 16 in plan view, the support 12 and the release sheet 16 can be easily distinguished from each other. As a result, the front side can be easily distinguished from the rear side. In the present embodiment, the case is explained in which the area of the support 12 is larger than that of the release sheet 16. However, the present invention is not limited to this example, and the area of the support may be same as that of the release sheet (the support may have the same shape as that of the release sheet) in plan view or it may be larger.

(Method of Manufacturing the Laminate)

A laminate 10 according to the present embodiment is manufactured as follows, for example. First, a support 12 and a release sheet 16 can be formed by a conventionally known film forming method. Examples of the film forming method include a calender film forming method, a casting method in an organic solvent, an inflation extrusion method in a closed system, a T-die extrusion method, a coextrusion method, and a dry laminate method.

When the pressure-sensitive adhesive layer is formed on the support 12, a pressure-sensitive adhesive composition solution is applied onto the support 12 to form a coating film, and the coating film is dried (heated and crosslinked as necessary) under a prescribed condition to form the pressure-sensitive adhesive layer.

Then, a resin composition solution that is a forming material of a resin sheet 14 is produced. The resin composition solution is applied onto the support 12 to a prescribed thickness to form a coating film, and the coating film is dried under a prescribed condition to form the resin sheet 14. The coating method is not especially limited. However, examples include roll coating, screen coating, and gravure coating. After that, the release sheet 16 is pasted to the resin sheet 14. The resin composition solution may be applied onto the release sheet 16 to form a coating film, and the coating film may be dried to form the resin sheet 14. In this case, the resin sheet 14 is pasted to the support 12 together with the release sheet 16. As stated above, the laminate 10 according to the present embodiment can be obtained.

(Method of Processing the Resin Sheet)

The resin sheet 14 that is provided in the laminate 10 according to the present embodiment can be processed as follows, for example.

First, the release sheet 16 is peeled off from the resin sheet 14. In the laminate 10, the peel force F1 between the support 12 and the resin sheet 14 is larger than the peel force F2 between the resin sheet 14 and the release sheet 16. Therefore, the release sheet 16 can be easily peeled off from the support 12 without peeling the resin sheet 14 off.

Then, the resin sheet 14 in a state of being laminated on the support 12 is pressed. The pressing can be performed using a conventionally known pressing apparatus. Because a part 12a where the resin sheet 14 is not laminated exists on the support 12, the resin spreads on the part 12a of the support. As a result, the protrusion of the resin on the support 12 can be prevented, and the attachment of the resin to a pressing plate or the like of a pressing apparatus can be prevented. Therefore, staining of the equipment can be suppressed. In addition, positioning of the resin sheet upon pressing can be performed using the part 12a of the support 12 where the resin sheet 14 is not laminated. An example of the pressing method is a method of heating the pressing plate (preferably to 60 to 110° C. and more preferably to 60 to 90° C.) to soften the resin sheet 14 and pressing the resin sheet 14 (preferably at 0.5 to 15 kg/cm² and more preferably at 2 to 5 kg/cm²). The amount of pressing is preferably 10 to 500 μm, and more preferably 30 to 300 μm as an amount of pushing from the contact of the pressing plate to the top surface of the resin sheet 14. In the pressing, both top and bottom pressing plates may be heated or only one of them may be heated.

Then, processes are performed such as a punching process by a Thomson blade or the like and a slitting process by a slitter or the like. After that, the resin sheet 14 is peeled off from the support 12 to obtain the resin sheet 14 is formed into a desired shape.

### EXAMPLES

Preferred examples of the invention are explained in detail below. However, the materials, the compounding amount, and the like described in these examples are not to limit the features of the invention as long as there is no special description of limitation.

<Preparation of the Support>

A support A made of PET (polyethylene terephthalate) having a size of 60 mm long×15 mm wide×38 μm thick was prepared.

A support B made of PET (polyethylene terephthalate) having a size of 55 mm long×15 mm wide×50 μm thick was prepared.

<Preparation of the Resin Sheet>

(Resin Sheet A)

The following ingredients were kneaded by a biaxial double kneading machine to prepare a kneaded material.

| | | |
|---|---|---|
| (1) Phenol resin (trade name: MEH-7851SS manufactured by | 3.6 | parts |
| Meiwa Plastic Industries, Ltd.) | | |
| (2) Epoxy resin (trade name: YSLV-(XY) manufactured by | 3.4 | parts |
| Nippon Steel Chemical Co., Ltd.) | | |
| (3) Curing accelerator (trade name: Curezol 2PHZ-PW | 0.1 | part |
| manufactured by Shikoku Chemicals Corporation) | | |
| (4) Elastomer (trade name: SIBSTAR072T-UC manufactured | 3 | parts |
| by Kaneka Corporation) | | |
| (5) Pigment (trade name: Carbon Black #20 manufactured | 0.1 | part |
| by Mitsubishi Chemicals, Inc.) | | |
| (6) Flame retardant (trade name: Rabitle FP-100 | 1.8 | parts |
| manufactured by FUSHIMI Pharmaceutical Co., Ltd.) | | |
| (7) Filler (trade name: FB-9454FC manufactured by DENKI | 88 | parts |
| KAGAKU KOGYO KABUSHIKI KAISHA) | | |

Then, extrusion molding was performed on the kneaded material to obtain a resin sheet A of 50 mm long×10 mm wide×300 μm thick.

(Resin Sheet B)

The following ingredients were kneaded by a biaxial double kneading machine to prepare a kneaded material.

| | |
|---|---|
| (1) Phenol resin (trade name: MEH-7851SS manufactured by | 4.6 parts |
| Meiwa Plastic Industries, Ltd.) | |
| (2) Epoxy resin (trade name: YSLV-80XY manufactured by | 4.4 parts |
| Nippon Steel Chemical Co., Ltd.) | |
| (3) Curing accelerator (trade name: Curezol 2PHZ-PW | 0.1 part |
| manufactured by Shikoku Chemicals Corporation) | |
| (4) Elastomer (trade name: SIBSTAR072T-UC manufactured | 3 parts |
| by Kaneka Corporation) | |
| (5) Pigment (trade name: Carbon Black #20 manufactured | 0.1 part |
| by Mitsubishi Chemicals, Inc.) | |
| (6) Flame retardant (trade name: Rabitle FP-100 | 1.8 parts |
| manufactured by FUSHIMI Pharmaceutical Co., Ltd.) | |
| (7) Filler (trade name: FB-9454FC manufactured by DENKI | 86 parts |
| KAGAKU KOGYO KABUSHIKI KAISHA) | |

Then, extrusion molding was performed on the kneaded material to obtain a resin sheet B of 50 mm long×10 mm wide×300 μm thick.

<Preparation of the Release Sheet>

A release sheet A made of PET (polyethylene terephthalate) having a size of 50 mm long×10 mm wide×300 μm thick was prepared.

<Preparation of the Laminate>

The resin sheet A was laminated on the support A, and the release sheet A was laminated thereon to form a laminate A.

The resin sheet B was laminated on the support B, and the release sheet A was laminated thereon to form a laminate B.

<Measurement of the Peel Force>

The peel force F1 between the support A and the resin sheet A was measured to be 0.3 N/10 mm.

The peel force F1 between the support B and the resin sheet B was measured to be 1.8 N/10 mm.

The peel force F2 between the resin sheet A and the release sheet A was measured to be 0.05 N/10 mm.

The peel force F2 between the resin sheet B and the release sheet A was measured to be 0.3 N/10 mm.

The peel force F1 and the peel force F2 are measured by AUTOGRAPH AGS-J (trade name) manufactured by Shimadzu Corporation under conditions of a measurement temperature of 23° C., a tensile speed of 0.3 m/min, and a peel angle of 180 degrees.

<Measurement of the Tensile Storage Modulus of the Support>

The tensile storage modulus of the support A at 25° C. was measured to be 1.6 GPa.

The tensile storage modulus of the support B at 25° C. was measured to be 3.15 GPa.

The tensile storage modulus was measured by RSA-2 (trade name) manufactured by TA Instruments under the condition of a frequency of 1 Hz.

<Measurement of the Coefficient of Linear Thermal Expansion of the Support>

The coefficient of linear thermal expansion of the support A was 5 ppm/° C. in a region (α1 region) of equal to or less than the glass transition temperature, and 31 ppm/° C. in a region (α2 region) of equal to or more than the glass transition temperature.

The coefficient of linear thermal expansion of the support B was 7 ppm/° C. in a region (α1 region) of equal to or less than the glass transition temperature, and 38 ppm/° C. in a region (α2 region) of equal to or more than the glass transition temperature.

The coefficient of linear thermal expansion was measured by TMA8310 manufactured by Rigaku Corporation under conditions of a temperature rise rate of 10° C./min, a measurement temperature region of 50 to 200° C., and a load of 24.5 mN.

### Evaluation of the Pressing

### Example 1

The laminate A was pressed using an instant vacuum laminating apparatus VS008-1515 manufactured by Mikado Technos Co., Ltd. The conditions of pressing were a pressing amount (a pushing distance) of 100 μm, a temperature of the pressing plate of 90° C., and an applied pressure of 5 kg/cm².

### Example 2

The laminate B was pressed using an instant vacuum laminating apparatus VS008-1515 manufactured by Mikado Technos Co., Ltd. The conditions of pressing were a pressing amount (a pushing distance) of 100 μm, a temperature of the pressing plate of 90° C., and an applied pressure of 5 kg/cm².

### Example 3

The laminate B was pressed using an instant vacuum laminating apparatus VS008-1515 manufactured by Mikado Technos Co., Ltd. The conditions of pressing were a pressing amount (a pushing distance) of 150 μm, a temperature of the pressing plate of 90° C., and an applied pressure of 5 kg/cm².

### Example 4

The laminate B was pressed using an instant vacuum laminating apparatus VS008-1515 manufactured by Mikado Technos Co., Ltd. The conditions of pressing were a pressing amount (a pushing distance) of 200 μm, a temperature of the pressing plate of 90° C., and an applied pressure of 5 kg/cm².

The results of pressing were evaluated as follows. That is, the case where there was no protrusion of the resin sheet from the support was evaluated as ◯, and the case where there was protrusion of the resin sheet from the support was evaluated as x. The results are shown in Table 1.

TABLE 1

| | Pressing Amount | | |
|---|---|---|---|
| | (Pushing | Temperature of | Presence of |
| | Distance) | Pressing Plate | Protrusion |
| Example 1 | 100 μm | 90° C. | ◯ |
| Example 2 | 100 μm | 90° C. | ◯ |
| Example 3 | 150 μm | 90° C. | ◯ |
| Example 4 | 200 μm | 90° C. | ◯ |

What is claimed is:

1. A laminate comprising:
a support,
a resin sheet that is laminated on a part of the support, and
a release sheet that is laminated on the resin sheet, wherein
a peel force F1 between the support and the resin sheet is larger than a peel force F2 between the resin sheet and the release sheet.

2. The laminate according to claim 1, wherein when the resin sheet in a state of being laminated on the support is pressed at a press temperature of 60 to 110° C., the resin sheet does not protrude from the support in plan view.

3. The laminate according to claim 1, wherein the tensile storage modulus of the support is 1.5 to 5 GPa at 25° C.

4. The laminate according to claim 1, wherein the area of the support is larger than the area of the release sheet in plan view.

5. The laminate according to claim 1, wherein the coefficient of linear thermal expansion of the support is 3 to 15 ppm/° C. in a region (α1 region) of equal to or less than the glass transition temperature, and 20 to 60 ppm/° C. in a region (α2 region) of equal to or more than the glass transition temperature.
